(19) United States
(12) Patent Application Publication
(10) Pub. No.: US 2025/0136260 A1
(43) Pub. Date: May 1, 2025

(54) CONTROL OF INPUT SOURCE BEHAVIOUR FOR MARINE VESSELS

(71) Applicant: VOLVO PENTA CORPORATION, Göteborg (SE)

(72) Inventors: David WALL, Fjärås (SE); Mikael AHLSTEDT, Göteborg (SE)

(73) Assignee: VOLVO PENTA CORPORATION, Göteborg (SE)

(21) Appl. No.: 18/930,373

(22) Filed: Oct. 29, 2024

(30) Foreign Application Priority Data
Nov. 1, 2023 (EP) 23207291.8

(51) Int. Cl. B63H 21/21; B63B 79/15; B63B 79/40; G05G 1/04; G05G 5/00

(52) U.S. Cl. CPC B63H 21/213; B63B 79/15; B63B 79/40; G05G 1/04; G05G 5/00; B63H 2021/216

(57) ABSTRACT

A maneuvering device for controlling navigation of a marine vessel is provided. The device has an input source movable between an equilibrium position and at least one displaced position, A variable resistance device adjusts a movement resistance of the input source. A control unit controls the variable resistance device by: obtaining a requested release input of the input source to move from the displaced position towards the equilibrium position, obtaining a longitudinal speed of the marine vessel, and controlling the variable resistance device to adjust said movement resistance of the input source based on the requested release input and the longitudinal speed.

### TECHNICAL FIELD

The disclosure relates generally to navigation control in marine vessels. In particular aspects, the disclosure relates to control of input source behaviour for marine vessels. The disclosure can be applied to marine vessels, such as leisure boats, ships, cruise ships, fishing vessels, yachts, ferries, among other vehicle types. Although the disclosure may be described with respect to a particular marine vessel, the disclosure is not restricted to any particular marine vessel.

### BACKGROUND

For electronic vessel control (EVC) systems, currently existing input sources are typically mechanical devices without any ability to provide force feedback to a driver when used. This means that they are freely movable until reaching their end positions as defined by mechanical limitations. These input sources are associated with drawbacks such as limited precision, potential user fatigue, limited customization, and compatibility challenges with modern EVC systems. Some existing input sources for marine applications involve force feedback to varying extents. The present inventors have identified further improvements concerning force feedback for marine vessel input sources.

### SUMMARY

According to a first aspect of the disclosure, there is provided a maneuvering device for controlling navigation of a marine vessel, comprising: an input source movable between an equilibrium position and at least one displaced position; a variable resistance device adapted to adjust a movement resistance of the input source; and a control unit configured to control the variable resistance device by: obtaining a requested release input of the input source to move from the displaced position towards the equilibrium position, obtaining a longitudinal speed of the marine vessel, and controlling the variable resistance device to adjust said movement resistance of the input source based on the requested release input and the longitudinal speed. The first aspect of the disclosure may seek to improve force feedback control of a marine vessel input source. A technical benefit may include a flexible and customized driving behaviour for the marine vessel, as well as an improved usability and operability of the input device.

Optionally in some examples, including in at least one preferred example, the control unit is configured to set a longitudinal speed threshold value, the movement resistance being adjusted depending on a value of the longitudinal speed in relation to the longitudinal speed threshold value. A technical benefit may include conditional decision-making and triggering of the movement resistance adjustment, which ensures that the adjustments are executed based on predefined criteria for improving efficiency, safety and accuracy of the device.

Optionally in some examples, including in at least one preferred example, the longitudinal speed threshold value indicates a docking mode or a cruising mode of the marine vessel. A technical benefit may include adapting control of the maneuvering device depending on whether the vessel is in a docking area or not, which enables finer control options, safer operation, and a more refined maneuvering.

Optionally in some examples, including in at least one preferred example, in the docking mode: the longitudinal speed is below the longitudinal speed threshold value, and the movement resistance is adjusted to an amount that allows the input source to move from the displaced position to the equilibrium position. A technical benefit may include providing a customized release behaviour in the docking mode which enables finer control options, safer operation, and a more refined maneuvering.

Optionally in some examples, including in at least one preferred example, in the cruising mode: the longitudinal speed is equal to or above the longitudinal speed threshold value, and the movement resistance is adjusted to an amount that locks movement of the input source in the displaced position. A technical benefit may include providing a customized release behaviour in the cruising mode which improves the usability of the maneuvering device.

Optionally in some examples, including in at least one preferred example, the control unit is configured to control the variable resistance device to adjust the resistance of movements of the input source by a fixed force value. A technical benefit may include an enhanced user experience and control by providing constant resistance or haptic feedback, thereby making it easier to maintain a desired position of the input source and navigate the marine vessel with consistent force levels.

Optionally in some examples, including in at least one preferred example, the control unit is configured to control the variable resistance device to adjust the resistance of movements of the input source by a variable force value. A technical benefit may include providing a dynamic adaptation to changing conditions, thereby providing more realistic and responsive feedback that matches the varying demands and constraints of the marine vessel for an improved control and user interaction.

Optionally in some examples, including in at least one preferred example, the control unit is further configured to control the variable resistance device based on navigable water conditions where the marine vessel is travelling. A technical benefit may include an enhanced safety and performance of the marine vessel by improving control procedures and compensating for environmental variables, thereby ensuring smoother and more effective navigation.

Optionally in some examples, including in at least one preferred example, the requested release input is ignored in response to said navigable water conditions indicating one of more of a wind speed, wave height and current strength being above respective predefined threshold values. A technical benefit may include mitigating the risk of responding to inadvertent release requests.

Optionally in some examples, including in at least one preferred example, the control unit is configured to control the variable resistance device to adjust the resistance of movements of the input source in response to said navigable water conditions indicating one of more of a wind speed, wave height and current strength being below said respective predefined threshold values. A technical benefit may include mitigating the risk of responding to inadvertent release requests.

Optionally in some examples, including in at least one preferred example, the longitudinal speed of the marine vessel is obtained from one or more of a speed sensor, an engine revolution sensor, a positioning system, a navigation system, a fleet management system, a light detection system, a radio detection system, a sonar detection system, or a nautical chart. A technical benefit may include real-time collection and integration of data from multiple sources, thereby enabling precise navigation, safety and control of the marine vessel by providing comprehensive information about the longitudinal speed.

According to a second aspect of the disclosure, there is provided a marine vessel comprising the maneuvering device according to the first aspect. The second aspect of the disclosure may seek to improve force feedback control of a marine vessel input source. A technical benefit may include a flexible and customized driving behaviour for the marine vessel, as well as an improved usability and operability of the input device.

According to a third aspect of the disclosure, there is provided a computer-implemented method for controlling a maneuvering device of a marine vessel, comprising: obtaining a requested release input of an input source of the maneuvering device to move from a displaced position towards an equilibrium position; obtaining a longitudinal speed of the marine vessel; and controlling adjustment of a movement resistance of the input source based on the requested release input and the longitudinal speed. The third aspect of the disclosure may seek to improve force feedback control of a marine vessel input source. A technical benefit may include a flexible and customized driving behaviour for the marine vessel, as well as an improved usability and operability of the input device.

According to a fourth aspect of the disclosure, there is provided a computer program product comprising program code for performing, when executed by the processing circuitry, the method of the third aspect. The fourth aspect of the disclosure may seek to improve force feedback control of a marine vessel input source. A technical benefit may include a flexible and customized driving behaviour for the marine vessel, as well as an improved usability and operability of the input device.

According to a fifth aspect of the disclosure, there is provided a non-transitory computer-readable storage medium comprising instructions, which when executed by the processing circuitry, cause the processing circuitry to perform the method of the third aspect. The fifth aspect of the disclosure may seek to improve force feedback control of a marine vessel input source. A technical benefit may include a flexible and customized driving behaviour for the marine vessel, as well as an improved usability and operability of the input device.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary system diagram of a marine vessel according to an example.

FIG. 2A is a visualization of a first state of an input source according to a first exemplary input source behaviour.

FIG. 2B is a visualization of a second state of the input source according to the first exemplary input behaviour of FIG. 2A.

FIG. 2C is a visualization of a third state of the input source according to the first exemplary input behaviour of FIG. 2A.

FIG. 2D is a visualization of a fourth state of the input source according to the first exemplary input behaviour of FIG. 2A.

FIG. 3A is a visualization of a first state of an input source according to a second exemplary input source behaviour.

FIG. 3B is a visualization of a second state of the input source according to the second exemplary input behaviour of FIG. 3A.

FIG. 3C is a visualization of a third state of the input source according to the second exemplary input behaviour of FIG. 3A.

FIG. 4 is a flowchart of an exemplary method for controlling a maneuvering device of a marine vessel according to an example.

FIG. 5 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

The present disclosure concerns controlling of force feedback of an input source for a marine vessel once it is released from a displaced position. More specifically, the control involves handling a request for the input source to be released from the displaced position towards an equilibrium position. The release behaviour is controlled based on a longitudinal speed of the marine vessel. By obtaining the longitudinal speed and controlling movement resistance of the input source accordingly, different release behaviours can be enabled for different longitudinal speed situations of the marine vessel. This may involve several technical benefits such as an adaptive, flexible and customized driving behaviour for the marine vessel, as well as an improved usability and operability of the input device.

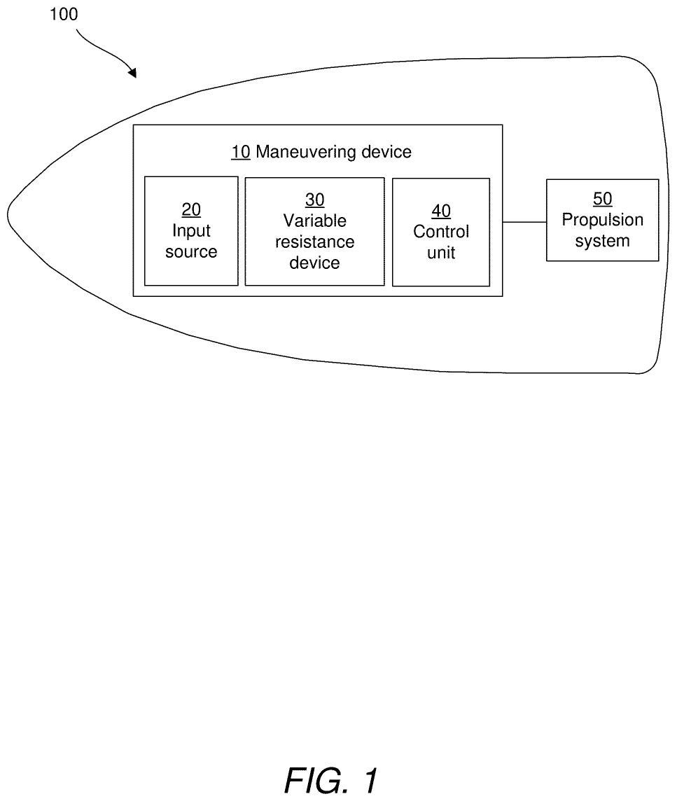

FIG. 1 is schematic illustration of a marine vessel 100 in which some of the inventive concepts of the present disclosure may be applied. The marine vessel 100 comprises a maneuvering device 10 and a propulsion system 50. The maneuvering device 10 is for controlling navigation of the marine vessel 100, and the propulsion system 50 is for propelling the marine vessel 100. Although not explicitly shown in FIG. 1, the skilled person will appreciate that the marine vessel 100 may include additional (sub)systems typically found in marine vessels, such as electrical systems, navigational systems, ballast systems, steering systems, HVAC systems, infotainment systems, hydraulic systems, safety systems, communication systems, auxiliary sensory systems, and so forth.

The propulsion system 50 is responsible for generating power required to propel the vessel through bodies of water, such as a sea, river, lake, and the like. The design and operation of the propulsion system 50 may vary depending on the type of vessel. The propulsion system 50 may comprise an electrical engine, a diesel engine, a gas turbine, a steam turbine, or water jets. The present disclosure is primarily concerned with electrical propulsion systems.

The electrical propulsion system 50 includes an electric motor adapted to convert electrical energy into mechanical energy for propulsion of the marine vessel 100. The electrical motor may be an AC motor or a DC motor. The electric motor is arranged to receive power from a power source, and optionally convert it to AC power if needed. The electrical propulsion system 50 further includes a power source, such as a battery system, fuel cell system or other energy systems. The power source may be chargeable, for instance when the marine vessel 100 is connected to an external power supply. The external power supply may be an on-shore or off-shore power supply. The power source may be a solar system of the marine vessel 100. The power source may be a fuel cell stack of the marine vessel 100. The electrical propulsion system 50 further includes a control system configured to receive signals from other systems of the marine vessel 100 and carry out controlled propulsion of the marine vessel 100 accordingly. The control system is configured to regulate the flow of electricity to the electric motor, which is then converted into mechanical energy for driving a propeller, thruster, or other device arranged to generate thrust for propelling the marine vessel 100. As the electric motor turns, the propeller is driven such that a flow of water is generated behind the marine vessel 100, thereby moving the marine vessel 100 through the water.

The maneuvering device 10 comprises an input source 20. The input source 20 shall be understood as a device that can be adapted to provide navigational commands to the marine vessel 100, such as commands pertaining to a speed or direction. The input source 20 may be a joystick. The input source 20 may comprise a handle, a lever, or some type of maneuverable axle. The input source 20 may be arranged to be maneuvered by an operator of the marine vessel 100, for example by a hand of the operator. The input source 20 may be movable in three degrees of freedom, i.e., pitch, roll and yaw. The pitch movement refers to up-and-down movement or rotation of the input source 20 around a horizontal axis, i.e., around the transverse axis which is an imaginary line running from port (left) to starboard (right) across the width of the marine vessel 100. The roll movement refers to side-to-side movement or rotation of the input source 20 around a longitudinal axis which is an imaginary line running from the bow (front) to the stern (back) of the marine vessel 100. The yaw movement refers to left-and-right movement or rotation of the input source 20 around a vertical axis, and corresponds to a turning or twisting motion of the marine vessel 100 by a change of direction or heading. These three degrees of freedom allow the input source 20 to control motion and orientation of the marine vessel 100 in three-dimensional space.

The input source 20 is arranged to be movable between an equilibrium position and one or more displaced positions. The equilibrium position shall be understood as a neutral or default position which the input source 20 is assuming upon no external forces are exerted on the input source 20. In some examples, the external forces are user-applied forces. In these examples, it is therefore understood that no user-applied force exertion on the input source 20 causes the input source 20 to be maintained at the equilibrium position. This is unless some other movement resistance is being applied to the input source 20, for instance by a variable resistance device 30, as will be discussed in more detail soon. The equilibrium position is typically a centered position of the input source 20 in relation to its mechanical end positions defined by physical limitations of the input source 20. However, other input source 20 designs may involve other positional details of equilibrium positions.

The displaced position shall be understood as a position being displaced from the equilibrium position. The displaced position may correspond to mechanical end positions of the input source 20 defined by physical limitations of the input source 20. The displaced position may correspond to an arbitrary position in between the equilibrium position and a mechanical end position.

The maneuvering device 10 may in some examples further comprise a positional sensor. The positional sensor is configured to determine positional data of the input source 20. This information may be used to determine whether the input source 20 is in a displaced position. The positional sensor may be a potentiometer, hall effect sensor, optical encoder, capacitive sensor, resistive film sensor, magnetic sensor, and the like.

The maneuvering device 10 comprises a variable resistance device 30. The variable resistance device 30 is arranged to provide force feedback, or haptic feedback, which are physical sensations or forces to a user in response to their interactions with the input source 20. The variable resistance device 30 is thus adapted to provide force feedback in response to the operator of the marine vessel 100 maneuvering the input source 20 between the various positions as discussed above.

The force feedback is provided by adjusting a movement resistance of the input source 20. The variable resistance device 30 may be a mechanical device. The variable resistance device 30 may be an electrical device. In non-limiting examples, the variable resistance device 30 may comprise an electric motor, an actuator, a piezoelectric device, a hydraulic device, a pneumatic device, a shape memory alloy, an electromagnetic device, a mechanical linkage, and the like, for adjusting the movement resistance of the input source 20. The variable resistance device 30 may be integrated into the input source 20, or provided externally to the input source 20 but configured to transmit the force feedback through connection with the input source 20. For external use, the variable resistance device 30 may involve an external controller that is configured to transmit signals to a controller of the input source 20 such that force feedback can be generated therein. In examples where the input source 20 is maneuverable in three degrees of freedom, the variable resistance device 30 may comprise a respective sub-device for each degree of freedom. The force feedback may thus be generated by a single or by several separate sub-devices in respective degrees of freedom.

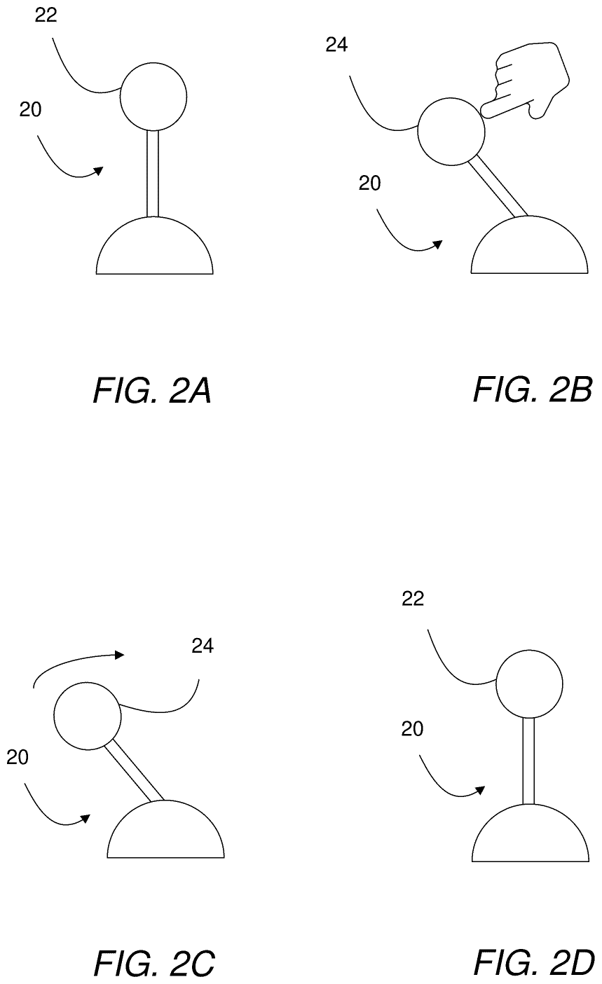

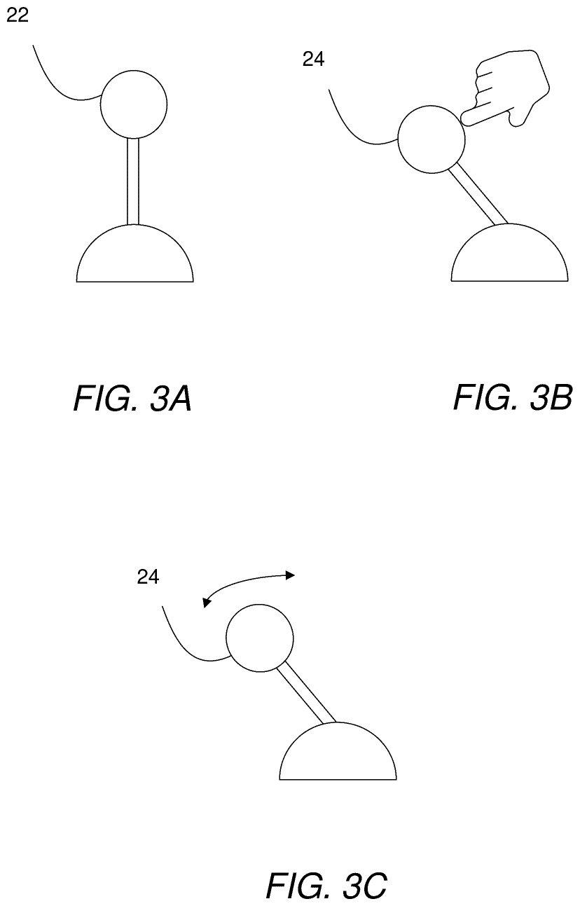

The resistance of movements of the input source 20 may be adjusted by a fixed force value or a variable force value. To this end, the magnitude and direction of the force value may vary or not depending on the type of force value being applied. In order to provide the force feedback, the direction of the force value is typically opposite from the movement direction of the input source 20, or the upcoming movement direction that is associated with a navigational request. For instance, movements by the input source 20 from the displaced position to the equilibrium position may involve an applied force value in a direction from the equilibrium position towards the displaced position. Since the force value may vary, the force value may cause different movement speeds of the input source 40 from the displaced position to the equilibrium position. The force value may completely counteract the movement of the input source 20 from the displaced position towards the equilibrium position, thereby locking the input source 20 in place. The force value may also be sufficiently small such that movement of the input source 20 is allowed from the displaced position towards the equilibrium position. This may be done at varying magnitudes such that the movement speed of the input source 20 varies. This will be discussed more according to two different examples later on with further reference to FIG. 2A-D and FIG. 3A-C, respectively.

The maneuvering device 10 comprises a control unit 40. The control unit 40 may form part of processing circuitry of a computer system of the marine vessel 100. The control unit 40 is configured to control the variable resistance device 30. The control unit 40 may be connected to the input source 20 and the variable resistance device 30 through any wired or wireless communication standards known in the art. Wireless communication standards may include IEEE 802.11, IEEE 802.15, ZigBee, WirelessHART, WiFi, Bluetooth®, BLE, RFID, WLAN, MQTT IoT, CoAP, DDS, NFC, AMQP, LoRaWAN, Z-Wave, Sigfox, Thread, EnOcean, mesh communication, or any other form of proximity-based device-to-device radio communication signal such as LTE Direct. The control unit 40 may be connected to other (sub)systems of the marine vessel 100 as discussed above.

The control unit 40 is configured to receive navigational requests from the input source 20 and cause controlled operations of the variable resistance device 30 accordingly. Such navigational requests may be received in response to the user performing maneuvering actions of the input source 20 between any of the positions as discussed above. To this end, the control unit 40 is responsible for controlling whether or not, and to what extent, the variable resistance device 30 is to adjust the movement resistance of the input source 20. The controlled operation may be carried out irrespective of the operation of the propulsion system 50. The received navigational requests may vary depending on what type of operation, such as requests pertaining to acceleration, deceleration, steering, rotation, position holding, station keeping, thruster control, automatic docking, autopilot, course corrections, heading control, speed control, anchoring, mooring, emergency maneuvers, and the like.

The present disclosure is primarily concerned with managing so-called release inputs of the input source 20 to move from a displaced position towards and equilibrium position. A release input shall be understood as a request to release the input source 20 from a displaced position such that a transition towards the equilibrium position is expected to be carried out. The release may be preceded by a user-applied force exertion on the input source 20, and the requested release input may be a release of said user-applied force exertion on the input source 20. To this end, a request for a release of the input source 20 typically occurs as a result of the operator of the marine vessel 100 having released a previously applied force exertion on the input source 20. This may be a force associated with any suitable direction as allowed by the input source 20.

In some examples, the control unit 40 may be configured to control the variable resistance device 30 based on navigable water conditions where the marine vessel 100 is travelling. Navigable water conditions may be any condition of the water that can affect the way the maneuvering device 10 is operated. For example, a wind speed, wave height and/or strength of currents of the water may affect how much force that needs to be applied to the input source 20 in order to control its behaviour. Other conditions may include water temperature and ice conditions.

The control unit 40 may be configured to set predefined threshold values associated with one or more of the navigable water conditions. The predefined threshold values may define limits for how the input source 20 shall be operable based on the prevailing conditions. The control unit 40 may be configured to obtain current navigable water conditions and compare these against the respective predefined threshold values, and carry out control of the variable resistance device 30 accordingly. In some examples, requested release inputs may be ignored in response to the navigable water conditions being above respective predefined threshold values. Ignoring certain requests may be useful in situations where said requests are triggered inadvertently. Such inadvertent request triggering may be a consequence of a navigable water condition affecting the maneuverability of the input source 20, for instance causing violent shaking on the marine vessel 100 such that the operator loses the grip on the input source 20. In some examples, requested release inputs may be responded to by relevant control of the variable resistance device 30 in response to the navigable water conditions being below or equal to respective predefined threshold values. This may correspond to a normal behaviour where no excessive navigable water conditions are envisaged.

The control unit 40 is configured to obtain a longitudinal speed of the marine vessel 100. The longitudinal speed may be obtained in at least near real-time, meaning that the longitudinal speed may be continuously (or at least repeatedly) obtained. The longitudinal speed is the speed at which the marine vessel 100 moves forward or backward along its length, as is also known as the speed-through-water. The longitudinal speed may be obtained through any known ways of obtaining a longitudinal speed of a marine vessel, such as inputs from one or more of a speed sensor, an engine revolution sensor, a positioning system, a navigation system, a fleet management system, a light detection system, a radar detection system, a sonar detection system, or a nautical chart, to name some examples.

Based on the requested release input and the obtained longitudinal speed, the control unit 40 is configured to control the variable resistance device 30 to adjust the movement resistance of the input source 20. Accordingly, the control of the release behaviour of the input source 20 is based on a, preferably real-time, longitudinal speed of the marine vessel 100. Different types of release behaviour control may therefore be conceived depending on the value of the longitudinal speed of the marine vessel 100, some of which are shown and will be further explained later on with reference to FIGS. 2A-D and FIGS. 3A-C.

In some examples, the control unit 40 may be configured to set a longitudinal speed threshold value. In these examples, the control unit 40 may be configured to control the variable resistance device 30 based on an outcome of a comparison between the longitudinal speed and the longitudinal speed threshold value. The longitudinal speed threshold value may be a fixed value, such as 2, 5, 10, or 20 knots, or any other similar speed value typically associated with marine vessels. The fixed value may relate to one or more speed constraints for the marine vessel 100. The speed constraints may be vessel limitations or external limitations. Vessel limitations pertain to properties of the marine vessel 100, and may include one or more of a hull design, a maximum power output, a weight, a dimensional property, and the like, of the marine vessel 100. External limitations pertain to properties surrounding the marine vessel 100 which, directly or indirectly, affect the speed of the marine vessel 100, and may include one or more of sea conditions, weather conditions, navigation rules, environmental rules, and the like.

The control unit 40 may be configured to set a plurality of longitudinal speed threshold values, each threshold value indicating a particular control action for the variable resistance device 30 to adjust the movement resistance of the input source 20. Each longitudinal speed threshold value may be set for a specific geographical ocean zone in relation to a land area. This may, in a non-limiting example, be realized as a first threshold value being set for a docking area, a second threshold value being set for an area immediately outside the docking area and having a certain distance to the docking area (e.g. 1 km, 5 km, and the like, depending on various factors such as type of dock, sea, etc.), a third threshold value being set for a neritic zone, and a fourth threshold value being set for an oceanic zone. Variations to this are conceived by the skilled person, such as pertaining to any of the external limitations or vessel limitations as described above, and/or with any suitable zone/area delimiting.

In some examples, the longitudinal speed threshold value indicates a docking mode or a cruising mode of the marine vessel 100. Different release behaviour of the input source 20 may thus be envisaged depending on whether the marine vessel 100 is present in a docking area or in an area outside of the docking area. These release behaviour are determined by how the control unit 40 controls the variable resistance device 30 to adjust the movement resistance of the input device 20. In the docking mode, the longitudinal speed may be below the longitudinal speed threshold value. To this end, upon the comparison indicating that the (current) longitudinal speed is below the longitudinal speed threshold value, a particular release behaviour is envisaged. In the cruising mode, the longitudinal speed may be equal to or above the longitudinal speed threshold value. To this end, upon the comparison indicating that the (current) longitudinal speed is equal to or above the longitudinal speed threshold value, another particular release behaviour is envisaged. The various release behaviours depending on the docking mode or the cruising mode will now be further explained in detail.

FIGS. 2A-D show an exemplary release behaviour of an input source 20, in this example being a joystick 20, in a docking mode. This very example corresponds to a request for a forward propulsion of the marine vessel 100, followed by a release of said request. Other navigation requests may similarly be envisaged in the docking mode where the joystick 20 is being maneuvered between an equilibrium position and a displaced position. Other types of requests may include, for instance, a backwards propulsion request or a rotation request, provided that at least a part of the request involves a movement from a displaced position to an equilibrium position.

In FIG. 2A, the joystick 20 is maintained in an equilibrium position 22. This may correspond to that no forward motion is being requested by the operator. The propulsion system 50 of the marine vessel 100 is thus not actively causing propulsion.

In FIG. 2B, an external force, in this case a lateral external force, has been applied to the joystick 20 by a hand of the operator. The joystick 20 has thus been maneuvered from the equilibrium position 22 to a displaced position 24. This may correspond to that a forward motion is being requested by the operator. The propulsion system 50 of the marine vessel 100 is thus actively causing propulsion.

In FIG. 2C, the lateral external force is no longer being exerted on the joystick 20. This is considered to represent a request for releasing the joystick 20 to from the displaced position 24 back towards the equilibrium position 22. This is where the controlling of the variable resistance device 30 by the control unit 40 takes place. Hence, the control unit 40 obtains the requested release input of the joystick 20 and the longitudinal speed of the marine vessel 100. As explained before, the outcome of the previously described comparison has resulted in an indication that the marine vessel 100 is in the docking mode. Accordingly, the movement resistance is adjusted to an amount that allows the input source 20 to move from the displaced position 24 to the equilibrium position 22, which is shown in FIG. 2D. The amount may depend on operating conditions of the marine vessel 100 and/or frictional constraints of the joystick 20. For example, certain joysticks may require less movement resistance than other joysticks for allowing movement thereof back to the equilibrium position 22.

FIGS. 3A-C show an exemplary release behaviour of an input source 20, in this example being a joystick 20, in a cruising mode. This very example corresponds to a request for a forward propulsion of the marine vessel 100, followed by a release of said request. Other navigation requests may similarly be envisaged in the cruising mode where the joystick 20 is being maneuvered between an equilibrium position and a displaced position. Other types of requests may include, for instance, a backwards propulsion request or a rotation request, provided that a part of the request involves a movement from a displaced position to an equilibrium position.

In FIG. 3A, the joystick 20 is maintained in an equilibrium position 22. This may correspond to that no forward motion is being requested by the operator. The propulsion system 50 of the marine vessel 100 is thus not actively causing propulsion.

In FIG. 3B, an external force, in this case a lateral external force, has been applied to the joystick 20 by a hand of the operator. The joystick 20 has thus been maneuvered from the equilibrium position 22 to a displaced position 24. This may correspond to that a forward motion is being requested by the operator. The propulsion system 50 of the marine vessel 100 is thus actively causing propulsion.

In FIG. 3C, the lateral external force is no longer being exerted on the joystick 20. This is considered to represent a request for releasing the joystick 20 to from the displaced position 24 back towards the equilibrium position 22. This is where the controlling of the variable resistance device 30 by the control unit 40 takes place. Hence, the control unit 40 obtains the requested release input of the joystick 20 and the longitudinal speed of the marine vessel 100. As explained before, the outcome of the previously described comparison has resulted in an indication that the marine vessel 100 is in the cruising mode. Accordingly, the movement resistance is adjusted to an amount that locks movement of the joystick in the displaced position 24. The amount may depend on operating conditions of the marine vessel 100 and/or frictional constraints of the joystick 20. For example, certain joysticks may require higher movement resistance than other joysticks for enabling the joystick to be locked in the displaced position 24. In relation to the example of FIGS. 2A-D, in the example of FIGS. 3A-C the amount of movement resistance is higher.

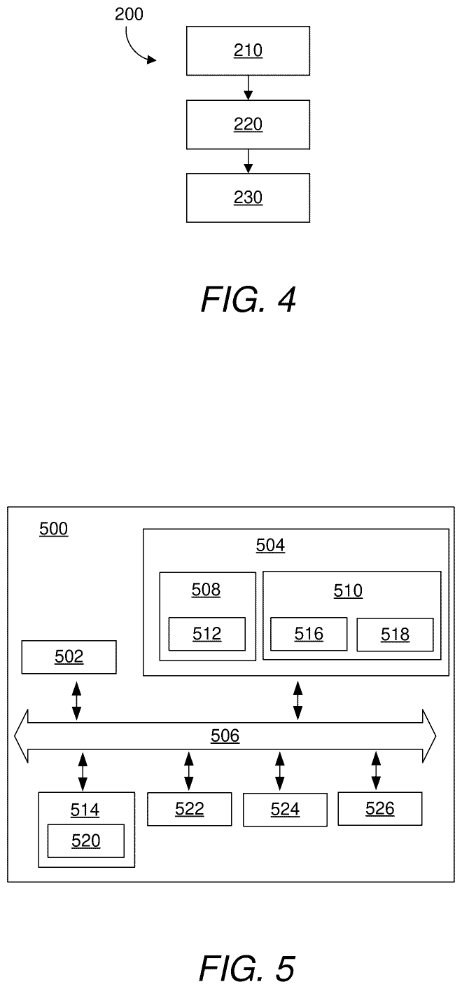

FIG. 4 is a flowchart of a method 200 for controlling a maneuvering device, such as the maneuvering device 10 as explained herein, of a marine vessel, such as the marine vessel 100 as explained herein. The method 200 may be carried out by a control unit, such as the control unit 40 as explained herein, which may form part of processing circuitry of a computer system. The method 200 involves at step 210 obtaining a requested release input of an input source, such as the input source 20 as explained herein, to move from a displaced position towards an equilibrium position, such as the positions 22, 24 explained herein. The method 200 involves at step 220 obtaining a longitudinal speed of the marine vessel. The method 200 involves at step 230 controlling adjustment of a movement resistance of the input source based on the requested release input and the longitudinal speed.

FIG. 5 is a schematic diagram of a computer system 500 for implementing examples disclosed herein. The computer system 500 is adapted to execute instructions from a computer-readable medium to perform these and/or any of the functions or processing described herein. The computer system 500 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 500 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 500 may comprise at least one computing device or electronic device capable of including firmware, hardware, and/or executing software instructions to implement the functionality described herein. The computer system 500 may include processing circuitry 502 (e.g., processing circuitry including one or more processor devices or control units), a memory 504, and a system bus 506. The computer system 500 may include at least one computing device having the processing circuitry 502. The system bus 506 provides an interface for system components including, but not limited to, the memory 504 and the processing circuitry 502. The processing circuitry 502 may include any number of hardware components for conducting data or signal processing or for executing computer code stored in memory 504. The processing circuitry 502 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 502 may further include computer executable code that controls operation of the programmable device.

The system bus 506 may be any of several types of bus structures that may further interconnect to a memory bus (with or without a memory controller), a peripheral bus, and/or a local bus using any of a variety of bus architectures. The memory 504 may be one or more devices for storing data and/or computer code for completing or facilitating methods described herein. The memory 504 may include database components, object code components, script components, or other types of information structure for supporting the various activities herein. Any distributed or local memory device may be utilized with the systems and methods of this description. The memory 504 may be communicably connected to the processing circuitry 502 (e.g., via a circuit or any other wired, wireless, or network connection) and may include computer code for executing one or more processes described herein. The memory 504 may include non-volatile memory 508 (e.g., read-only memory (ROM), erasable programmable read-only memory (EPROM), electrically erasable programmable read-only memory (EEPROM), etc.), and volatile memory 510 (e.g., random-access memory (RAM)), or any other medium which can be used to carry or store desired program code in the form of machine-executable instructions or data structures and which can be accessed by a computer or other machine with processing circuitry 502. A basic input/output system (BIOS) 512 may be stored in the non-volatile memory 508 and can include the basic routines that help to transfer information between elements within the computer system 500.

The computer system 500 may further include or be coupled to a non-transitory computer-readable storage medium such as the storage device 514, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 514 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 514 and/or in the volatile memory 510, which may include an operating system 516 and/or one or more program modules 518. All or a portion of the examples disclosed herein may be implemented as a computer program 520 stored on a transitory or non-transitory computer-usable or computer-readable storage medium (e.g., single medium or multiple media), such as the storage device 514, which includes complex programming instructions (e.g., complex computer-readable program code) to cause the processing circuitry 502 to carry out actions described herein. Thus, the computer-readable program code of the computer program 520 can comprise software instructions for implementing the functionality of the examples described herein when executed by the processing circuitry 502. In some examples, the storage device 514 may be a computer program product (e.g., readable storage medium) storing the computer program 520 thereon, where at least a portion of a computer program 520 may be loadable (e.g., into a processor) for implementing the functionality of the examples described herein when executed by the processing circuitry 502. The processing circuitry 502 may serve as a controller or control system for the computer system 500 that is to implement the functionality described herein.

The computer system 500 may include an input device interface 522 configured to receive input and selections to be communicated to the computer system 500 when executing instructions, such as from a keyboard, mouse, touch-sensitive surface, etc. Such input devices may be connected to the processing circuitry 502 through the input device interface 522 coupled to the system bus 506 but can be connected through other interfaces, such as a parallel port, an Institute of Electrical and Electronic Engineers (IEEE) 1394 serial port, a Universal Serial Bus (USB) port, an IR interface, and the like. The computer system 500 may include an output device interface 524 configured to forward output, such as to a display, a video display unit (e.g., a liquid crystal display (LCD) or a cathode ray tube (CRT)). The computer system 500 may include a communications interface 526 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1: A maneuvering device (10) for controlling navigation of a marine vessel (100), comprising: an input source (20) movable between an equilibrium position (22) and at least one displaced position (24); a variable resistance device (30) adapted to adjust a movement resistance of the input source (20); and a control unit (40) configured to control the variable resistance device (30) by: obtaining a requested release input of the input source (20) to move from the displaced position (24) towards the equilibrium position (22), obtaining a longitudinal speed of the marine vessel (100), and controlling the variable resistance device (30) to adjust said movement resistance of the input source (20) based on the requested release input and the longitudinal speed.

Example 2: The maneuvering device (10) of example 1, wherein the control unit (40) is configured to set a longitudinal speed threshold value, the movement resistance being adjusted depending on a value of the longitudinal speed in relation to the longitudinal speed threshold value.

Example 3: The maneuvering device (10) of example 2, wherein the longitudinal speed threshold value indicates a docking mode or a cruising mode of the marine vessel (100).

Example 4: The maneuvering device (10) of example 3, wherein in the docking mode: the longitudinal speed is below the longitudinal speed threshold value, and the movement resistance is adjusted to an amount that allows the input source (20) to move from the displaced position (24) to the equilibrium position (22).

Example 5: The maneuvering device (10) of any of examples 3-4, wherein in the cruising mode: the longitudinal speed is equal to or above the longitudinal speed threshold value, and the movement resistance is adjusted to an amount that locks movement of the input source (20) in the displaced position.

Example 6: The maneuvering device (10) of any of examples 1-5, wherein the control unit (40) is configured to control the variable resistance device (30) to adjust the resistance of movements of the input source (20) by a fixed force value.

Example 7: The maneuvering device (10) of any of examples 1-5 wherein the control unit (40) is configured to control the variable resistance device (30) to adjust the resistance of movements of the input source (20) by a variable force value.

Example 8: The maneuvering device (10) of any of examples 1-7, wherein the control unit (40) is further configured to control the variable resistance device (30) based on navigable water conditions where the marine vessel (100) is travelling.

Example 9: The maneuvering device (10) of example 8, wherein the requested release input is ignored in response to said navigable water conditions indicating one of more of a wind speed, wave height and current strength being above respective predefined threshold values.

Example 10: The maneuvering device (10) of example 9, wherein the control unit (40) is configured to control the variable resistance device (30) to adjust the resistance of movements of the input source (20) in response to said navigable water conditions indicating one of more of a wind speed, wave height and current strength being below said respective predefined threshold values.

Example 11: The maneuvering device (10) of any of examples 1-10, wherein in the equilibrium position (22) no user-applied forces are exerted on the input source (20).

Example 12: The maneuvering device (10) of any of examples 1-11, wherein the requested release input is preceded by a user-applied force exertion on the input source (20).

Example 13: The maneuvering device (10) of any of examples 1-12, wherein the requested release input is a release of a user-applied force exertion on the input source (20).

Example 14: The maneuvering device (10) of any of examples 1-13, further comprising a positional sensor to determine positional data of the input source (20), the control unit (40) being configured to obtain the positional data for determining whether the input source (20) is in the displaced position.

Example 15: The maneuvering device (10) of any of examples 1-14, wherein the longitudinal speed of the marine vessel (100) is obtained from one or more of a speed sensor, an engine revolution sensor, a positioning system, a navigation system, a fleet management system, a light detection system, a radio detection system, a sonar detection system, or a nautical chart.

Example 16: The maneuvering device (10) of any of examples 1-15, wherein the variable resistance device (30) is a mechanical device.

Example 17: The maneuvering device (10) of any of examples 1-16, wherein the variable resistance device (30) is an electrical device.

Example 18: The maneuvering device (10) of any of examples 1-17, wherein the input source (20) is a joystick.

Example 19: A marine vessel (100) comprising the maneuvering device (10) according to any of examples 1-18.

Example 20: A computer-implemented method (200) for controlling a maneuvering device (10) of a marine vessel (100), comprising: obtaining (210) a requested release input of an input source (20) of the maneuvering device (10) to move from a displaced position (24) towards an equilibrium position (22); obtaining (220) a longitudinal speed of the marine vessel (100); and controlling (230) adjustment of a movement resistance of the input source (20) based on the requested release input and the longitudinal speed.

Example 21: A method (300) for controlling navigation of a marine vessel (100), comprising: providing (310) a maneuvering device (10) according to any of examples 1-18; controlling (320) navigation of the marine vessel (100) by navigational commands from the maneuvering device (10).

Example 22: A computer program product comprising program code for performing, when executed by the processing circuitry, the method of example 20.

Example 23: A non-transitory computer-readable storage medium comprising instructions, which when executed by the processing circuitry, cause the processing circuitry to perform the method of example 20.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A maneuvering device for controlling navigation of a marine vessel, comprising:
an input source movable between an equilibrium position and at least one displaced position;
a variable resistance device adapted to adjust a movement resistance of the input source; and
a control unit configured to control the variable resistance device by:
obtaining a requested release input of the input source to move from the displaced position towards the equilibrium position,
obtaining a longitudinal speed of the marine vessel, and
controlling the variable resistance device to adjust said movement resistance of the input source based on the requested release input and the longitudinal speed.

2. The maneuvering device of claim 1, wherein the control unit is configured to set a longitudinal speed threshold value, the movement resistance being adjusted depending on a value of the longitudinal speed in relation to the longitudinal speed threshold value.

3. The maneuvering device of claim 2, wherein the longitudinal speed threshold value indicates a docking mode or a cruising mode of the marine vessel.

4. The maneuvering device of claim 3, wherein in the docking mode:
the longitudinal speed is below the longitudinal speed threshold value, and
the movement resistance is adjusted to an amount that allows the input source to move from the displaced position to the equilibrium position.

5. The maneuvering device of claim 3, wherein in the cruising mode:
the longitudinal speed is equal to or above the longitudinal speed threshold value, and
the movement resistance is adjusted to an amount that locks movement of the input source in the displaced position.

6. The maneuvering device of claim 1, wherein the control unit is configured to control the variable resistance device to adjust the resistance of movements of the input source by a fixed force value.

7. The maneuvering device of claim 1, wherein the control unit is configured to control the variable resistance device to adjust the resistance of movements of the input source by a variable force value.

8. The maneuvering device of claim 1, wherein the control unit is further configured to control the variable resistance device based on navigable water conditions where the marine vessel is travelling.

9. The maneuvering device of claim 8, wherein the requested release input is ignored in response to said navigable water conditions indicating one of more of a wind speed, wave height and current strength being above respective predefined threshold values.

10. The maneuvering device of claim 9, wherein the control unit is configured to control the variable resistance device to adjust the resistance of movements of the input source in response to said navigable water conditions indicating one of more of a wind speed, wave height and current strength being below said respective predefined threshold values.

11. The maneuvering device of claim 1, wherein in the equilibrium position no user-applied forces are exerted on the input source.

12. The maneuvering device of claim 1, wherein the requested release input is preceded by a user-applied force exertion on the input source.

13. The maneuvering device of claim 1, wherein the requested release input is a release of a user-applied force exertion on the input source.

14. The maneuvering device of claim 1, further comprising a positional sensor to determine positional data of the input source, the control unit being configured to obtain the positional data for determining whether the input source is in the displaced position.

15. The maneuvering device of claim 1, wherein the longitudinal speed of the marine vessel is obtained from one or more of a speed sensor, an engine revolution sensor, a positioning system, a navigation system, a fleet management system, a light detection system, a radio detection system, a sonar detection system, or a nautical chart.

16. A marine vessel comprising the maneuvering device according to claim 1.

17. A computer-implemented method for controlling a maneuvering device of a marine vessel, comprising:
obtaining a requested release input of an input source of the maneuvering device to move from a displaced position towards an equilibrium position;
obtaining a longitudinal speed of the marine vessel; and
controlling adjustment of a movement resistance of the input source based on the requested release input and the longitudinal speed.

18. A method for controlling navigation of a marine vessel, comprising:
providing a maneuvering device according to claim 1; and
controlling navigation of the marine vessel by navigational commands from the maneuvering device.

19. A computer program product comprising program code for performing, when executed by the processing circuitry, the method of claim 17.

20. A non-transitory computer-readable storage medium comprising instructions, which when executed by the processing circuitry, cause the processing circuitry to perform the method of claim 17.
